(19) United States
(12) Patent Application Publication
(10) Pub. No.: US 2014/0290090 A1
(43) Pub. Date: Oct. 2, 2014

(54) SYSTEM AND METHOD FOR DRYING SUBSTRATES

(71) Applicant: JST Manufacturing, Inc., Boise, ID (US)

(72) Inventors: David Campion, Boise, ID (US); Timothy Wilson, Boise, ID (US); Ryan Zrno, Boise, ID (US)

(21) Appl. No.: 14/210,421

(22) Filed: Mar. 13, 2014

Related U.S. Application Data
(63) Continuation-in-part of application No. 12/862,703, filed on Aug. 24, 2010, now abandoned.

(51) Int. Cl. F26B 20/00

(52) U.S. Cl. CPC F26B 20/00
USPC 34/381; 34/60

(57) ABSTRACT

A method for drying a wet semiconductor substrate includes immersing the wet substrate in a rinsing liquid in a sealed drying chamber, producing a volume of vaporized drying fluid in a vapor generator, establishing fluid communication between the vapor generator and the drying chamber, transferring the vaporized drying fluid to the drying chamber by removing the rinsing liquid from the drying chamber, and allowing the vaporized drying fluid to condense on the wet substrate. The method further includes providing vacuum pressure within the drying chamber and backfilling the drying chamber with an inert gas to substantially achieve atmospheric pressure.

### PRIORITY CLAIM

The present application is a continuation-in-part of U.S. patent application Ser. No. 12/862,703, filed on Aug. 24, 2010 and entitled SYSTEM AND METHOD FOR DRYING SUBSTRATES, the disclosure of which is incorporated herein by reference in its entirety.

### FIELD OF THE DISCLOSURE

The present disclosure relates generally to the drying of substrates following wet processing steps. More specifically, the present disclosure relates to a system and method for drying substrates that is effective with substrates having high aspect ratio features or MEMS features that can tend to trap liquids after rinsing.

### BACKGROUND

The semiconductor manufacturing process typically includes multiple “wet” processing steps, which can involve acids, bases, and solvents, for example. Each of these steps is frequently followed by a rinse with de-ionized (DI) water, and then drying. The drying step is often the last step that a given substrate will encounter before its next process step. It is therefore desirable that drying be as complete as possible and not introduce any undesirable conditions that could interfere with subsequent process steps or degrade the quality or function of the finished semiconductor.

There are a variety of known apparatus and methods for drying semiconductor substrates. However, certain semiconductor substrates, such as those having micro-electromechanical systems (MEMS) and photovoltaics, can have deep vias and/or high aspect ratio features on the surface, which can present a particular challenge for drying. These types of features can contain or trap water after rinsing, which can leave surface contaminants in the form of water spotting. Water remaining on a substrate can also cause long cycle times and incomplete drying, potentially leading to stiction of MEMS devices on the substrate. Liquid spots left on a semiconductor wafer surface can also cause oxidation that damages components on the wafer.

### SUMMARY

The present disclosure advantageously addresses one or more of the aforementioned issues by providing a system and method for drying semiconductor substrates, including those with high aspect ratios. In one exemplary embodiment, wet semiconductor substrates are fully immersed in a drying liquid, removed from the drying liquid, and then exposed to vacuum pressure to remove any remaining liquid.

In one embodiment, an inert gas is introduced into the drying chamber prior to exposing the substrate to vacuum pressure. Then, the pressure inside the drying chamber is reduced to evacuate the inert gas and evaporate any residual drying liquid and remove it from the chamber. Finally, the chamber is backfilled with gas to bring it back up to atmospheric pressure, to allow removal of the dried substrates.

In one embodiment, the drying liquid comprises isopropyl alcohol.

In one embodiment, the inert gas comprises nitrogen, and in one embodiment, the inert gas is heated before it is introduced into the drying chamber.

In one embodiment, the vacuum pressure can fall within the range of about 100 torr to about 10 torr.

In another embodiment, the present disclosure also provides a drying chamber for drying wet substrates. In one embodiment the drying chamber comprises an openable pressure vessel, defining an interior and having an airtight seal when closed, and is configured to withstand internal vacuum pressure, and to contain drying liquid selectively filled to an immersion depth sufficient to substantially completely immerse a substrate therein. The pressure vessel includes a liquid inlet, in communication with the interior, configured to selectively allow the drying liquid thereinto, and a liquid outlet, in communication with the interior, configured to selectively allow the drying liquid to be withdrawn therefrom. The pressure vessel also includes a gas inlet, in communication with the interior, configured to selectively allow gas thereinto, and a gas outlet, in communication with the interior of the pressure vessel, configured to selectively allow withdrawal of gas therefrom, to produce a vacuum environment therein.

The present disclosure also provides a system for drying a substrate. In one embodiment the system includes a drying chamber, a drying liquid reservoir in fluid communication with the drying chamber, a liquid pump, an inert gas supply in fluid communication with the drying chamber, and a vacuum pressure source in fluid communication with the drying chamber. The drying chamber is configured to receive a wet substrate, and to contain a drying liquid up to an immersion depth sufficient to substantially completely immerse the substrate. The drying liquid reservoir is configured to contain a supply of the drying liquid, and the liquid pump is configured to pump the drying liquid between the drying chamber and the drying liquid reservoir. The inert gas supply is configured to provide an inert gas into the drying chamber. The vacuum pressure source is configured to produce vacuum pressure within the drying chamber after the substrate has been immersed in and removed from the drying liquid.

The present disclosure will now be described more fully with reference to the accompanying drawings, which are intended to be read in conjunction with both this summary, the detailed description, and any particular embodiments specifically discussed or otherwise disclosed. This disclosure may, however, be embodied in many different forms and should not be construed as limited to the embodiments set forth herein; rather, these embodiments are provided by way of illustration only so that this disclosure will be thorough, and fully convey the full scope of the invention to those skilled in the art.

### BRIEF DESCRIPTION OF THE DRAWINGS

FIG. 1 is a schematic diagram of one embodiment of a system for drying substrates.

FIG. 2 is a flowchart illustrating the steps performed in one embodiment of a method for drying substrates according to the present disclosure.

FIG. 3 is a schematic diagram of another embodiment of a system for drying substrates by condensing drying liquid upon the substrate.

FIG. 4 is a flowchart illustrating the steps performed in embodiment of a method for drying substrates using the apparatus of FIG. 3.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

In the following description, reference is made to the accompanying drawings that form a part thereof, and in which is shown by way of illustration specific exemplary embodiments in which the invention may be practiced. These embodiments are described in sufficient detail to enable those skilled in the art to practice the invention, and it is to be understood that modifications to the various disclosed embodiments may be made, and other embodiments may be utilized, without departing from the spirit and scope of the present invention. The following detailed description is, therefore, not to be taken in a limiting sense.

As noted above, some of the known methods for drying substrates, such as semiconductor substrates, can leave surface contaminants in the form of water spotting, and can also cause incomplete drying, potentially leading to stiction of MEMS devices on the substrate. Those of skill in the art will recognize that the term “stiction” is an informal contraction of the term “static friction.” As is well known, two solid objects pressing against each other (but not sliding) will require some threshold of force parallel to the surface of contact in order to overcome static cohesion. Moreover, in situations where two surfaces with areas below the micrometer range come into close proximity (as in MEMS devices), those surfaces may adhere together. At this scale, electrostatic and/or Van der Waals and hydrogen bonding forces become significant, in addition to conventional static friction. The phenomenon of two such surfaces being adhered together in this manner is called stiction.

Some prior drying methods use a drying liquid, such as isopropyl alcohol (IPA), in a vapor phase, combined with the application of vacuum pressure to remove remaining water from a substrate. As noted above, between processing steps, semiconductor substrates are frequently rinsed with de-ionized (DI) water. In the following discussion, this water will be referred to as “rinse water” or simply “water.” In one prior method, IPA vapor is introduced into a chamber in which the substrates are located, and condenses on the substrate, where it mixes with the rinse water and relieves surface tension. The static pressure inside of the chamber is then reduced, causing the mixture of water and IPA to evaporate from the substrate.

Another previous drying method uses a Marangoni dryer. This drying method employs a vessel containing rinse water with IPA liquid on the surface of the water. The substrates are either lifted out of the vessel or the surface of the liquid is lowered below the substrate. The substrate becomes dried due to the difference in surface tension between the IPA and rinse water because of what is known as the “Marangoni Effect.” As known by those of skill in the art, the Marangoni Effect causes mass transfer along an interface due to a surface tension gradient. A surface tension gradient, in turn, can be caused by a concentration gradient. Since a liquid with a high surface tension pulls more strongly on the surrounding liquid than one with a low surface tension, the presence of a gradient in surface tension will naturally cause the liquid to flow away from regions of low surface tension. In a Marangoni Dryer, an alcohol vapor (IPA) or other organic compound in gas, vapor, or aerosol form, is blown through a nozzle over a wet wafer surface, producing a surface tension gradient in the liquid. This allows gravity to more-easily pull the liquid off the wafer surface.

Both of the prior methods described above can present some drawbacks when drying substrates with high aspect ratio features. Large amounts of rinse water can be contained or trapped in these high aspect ratio features in comparison to typical semiconductor devices. In the IPA vapor and vacuum pressure method, the relatively large water volume can prevent adequate amounts of IPA vapor from condensing on the substrate before equilibrium is reached with the saturated IPA vapor inside the vessel. Therefore, when the vacuum stage begins, there can still be a high concentration of water versus IPA present on the substrate's surface. This remaining water then boils off during the vacuum process, which can leave surface contaminants in the form of water spotting. Trapped remaining water can also be a problem with Marangoni Dryers. As noted above, liquid spots left on the wafer surface can cause oxidation that damages components on the wafer. Likewise, water remaining on the substrate during the vacuum process can also lead to long cycle times and incomplete drying, potentially leading to stiction of MEMS devices on the substrate.

Advantageously, the present disclosure describes a system and method for drying substrates with high aspect ratio features. As used in the following description, the term “substrate” can include any supporting structure including, but not limited to, a semiconductor substrate that has an exposed substrate surface. Semiconductor substrates can include silicon, epitaxial silicon, silicon-on-insulator (SOI), silicon-on-sapphire (SOS), doped and undoped semiconductors, epitaxial layers of silicon supported by a base semiconductor foundation, and other semiconductor structures. When reference is made to a substrate in the following description, previous process steps may have been utilized to form regions or junctions in or over the base substrate or foundation. The substrate need not be semiconductor-based, but may be any support structure suitable for supporting a device, including, but not limited to, metals, alloys, glasses, natural and synthetic polymers, ceramics, fabrics, and any other suitable materials, as would be apparent to one of ordinary skill in the art, given the benefit of this disclosure.

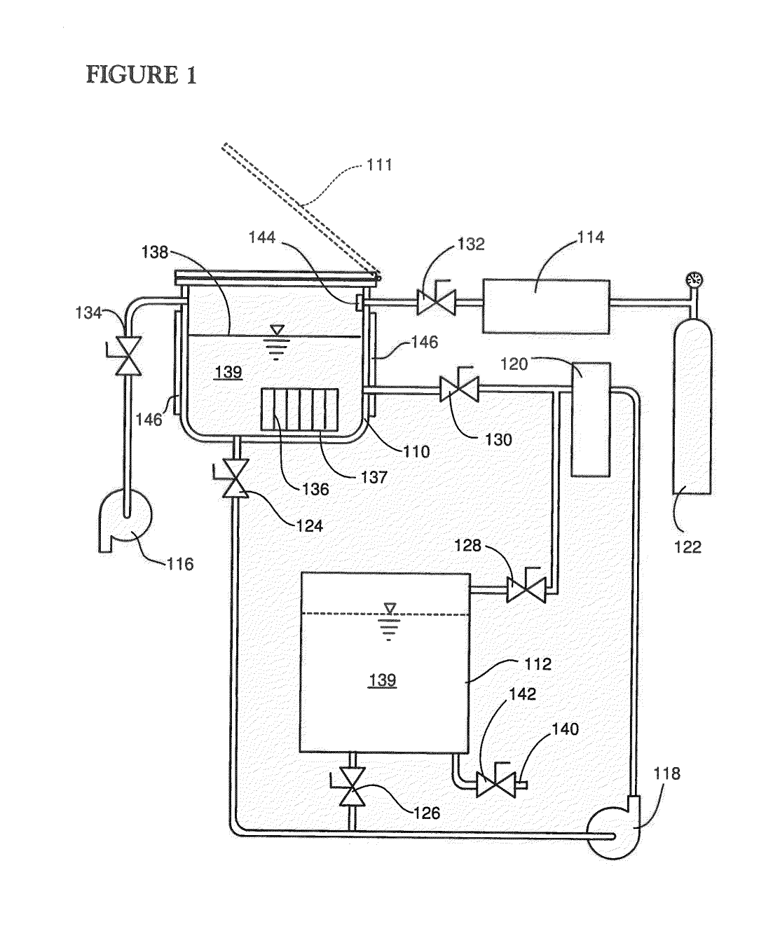

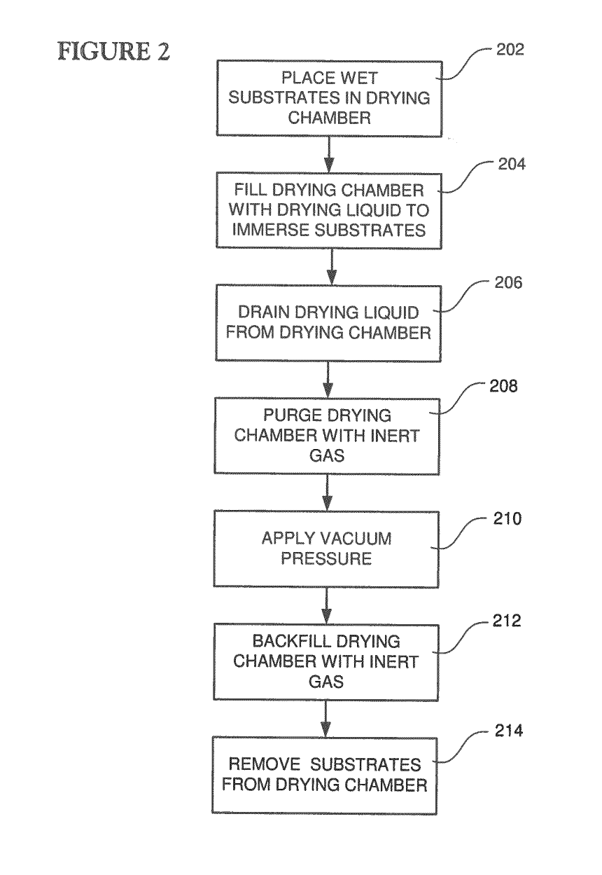

A schematic diagram of one embodiment of a semiconductor drying system is shown in FIG. 1. A flowchart outlining the process steps performed in one embodiment of a method for drying substrates having high aspect ratio features is shown in FIG. 2. The method disclosed herein involves the use of a drying liquid immersion for drying substrates. Semiconductor-grade isopropyl alcohol (IPA) can be used as the drying liquid, because it combines several desirable properties, such as miscibility in water, low surface tension, high vapor pressure, high molecular weight, and high purity. These properties are desirable in a drying liquid to allow it to easily displace residual rinse water, and quickly evaporate without leaving contamination or water spots behind. For example, a drying liquid having a surface tension against air of about 15-30 dyn/cm at 20° C. can be used. For comparison, a surface tension value for wetting a silicone surface in air is about 27 dyn/cm. A drying liquid having a vapor pressure between 20-300 mmHg at 20° C., and a molecular weight greater than 20-150 g/mol can be used. These vapor pressure and molecular weight properties affect the evaporation rate of the drying liquid. The lower limits for vapor pressure and molecular weight presented above are approximately the properties of water. When these properties of the drying liquid are greater than the same properties of the rinse water, the drying liquid will give at least some benefit during the heated vacuum process. The upper limits for vapor pressure and molecular weight are practical limits that help to limit evaporation, so that excessive liquid isn't wasted during the immersion process. Nevertheless, it is to be understood that the method disclosed herein can be practiced using drying liquids with higher values for vapor pressure and molecular weight.

High-purity semiconductor-grade IPA is often greater than 99.5% pure with low limits on dissolved metals and other contaminants. Other drying liquids with acceptable performance characteristics can also be used, such as alcohols and other solvents. For example, acetone and methyl alcohol are among the liquids that have properties (e.g. surface tension, vapor pressure, molecular weight) like those outlined above, and are used in the semiconductor industry. Naturally, it is desirable to assess any proposed drying liquid with respect to environmental and health issues, and whether it leaves a clean substrate surface. By immersing the substrates in the drying liquid, all surfaces of the substrate material will be wetted with the drying liquid. This allows the rinse water, which may have been trapped by high aspect ratio substrate features, to be displaced by the bulk drying liquid, and removed from the chamber when the drying liquid is drained.

As shown in FIG. 1, one embodiment of a drying system in accordance with the present disclosure includes a drying chamber 110, which is in fluid communication with a drying liquid reservoir 112, an inert gas heater 114 and vacuum pump 116. The drying chamber 110 and other elements of the system are shown with their associated conduits and plumbing components. The drying chamber 110 can include an openable lid or door 111, which allows access to the interior of the chamber 110, but can be closed to provide an airtight seal during use. The drying chamber 110 comprises a pressure vessel, capable of containing vacuum pressure relative to standard atmospheric pressure. The drying chamber 110 can also be configured to be capable of containing higher pressures, above atmospheric pressure, if desired. In one embodiment, the drying chamber 110 is made of stainless steel, which is strong and resistant to a wide variety of chemical agents. Drying chambers 110 made of other materials can also be used. The drying chamber 110 and drying liquid reservoir 112 are also in fluid communication with a drying liquid transfer pump 118 and drying liquid filter 120. The drying liquid pump can be an oil-less centrifugal pump. It is desirable that the drying liquid pump be constructed of high-purity materials that are chemically compatible with the drying liquid, such as stainless steel, fluoropolymers, etc., to avoid contaminating the substrate. Common drying liquids, such as isopropyl alcohol, evaporate into potentially explosive vapors. Consequently, it is also desirable that electrical components associated with the pump, such as an electric motor, meet appropriate standards, such as the National Electric Code (NEC). The inert gas heater 114 is in fluid communication with an inert gas supply 122, such as a tank of compressed gas. A variety of fluid conduits and valves interconnect these elements to allow the transfer of fluids.

With valves 124 and 128 closed, and valves 126 and 130 open, drying liquid 139 can be pumped by the drying liquid transfer pump 118 from the drying liquid reservoir 112, through the drying liquid filter 120, and into the drying chamber 110. To remove drying liquid from the drying chamber 110, valves 126 and 130 are closed, and valves 124 and 128 are opened, allowing the drying liquid 139 to drain from the drying chamber 110, and be pumped by the drying liquid transfer pump 118 through the filter 120, and back into the drying liquid reservoir 112. To introduce inert gas into the drying chamber 110, inert gas from the inert gas supply 122 (which is typically at elevated pressure) flows through the inert gas heater 114 and valve 132, and into the drying chamber 110. The vacuum pump 116 can pump gasses out of the drying chamber 110 through valve 134 in order to both purge the drying chamber 110 and to provide vacuum pressure in the drying chamber 110.

In the embodiment shown in FIG. 1, only a single drying chamber 110 is used. Viewing the flowchart of FIG. 2 in conjunction with FIG. 1, a batch of wet semiconductor substrates 136, usually batch processed in a process cassette or carrier 137, are placed inside the drying chamber 110, and the chamber lid 111 is closed. This is step 202 in FIG. 2. The substrates 136 are substrates having residual rinse water remaining from a previous processing step.

With valves 124 and 128 closed, and valves 126 and 130 open, drying liquid 139 is pumped from the drying liquid reservoir 112 into the drying chamber 110. The drying chamber 110 is filled up to some fill level, indicated at 138, sufficient to immerse the substrates 136. This is step 204 in FIG. 2. To reduce process time, the drying chamber 110 can be pre-filled with the drying liquid prior to placement of the substrates 136 inside the chamber 110. With the substrates 136 immersed in the drying liquid, the drying liquid can displace the residual rinse water from the substrates 136.

As noted above, the drying liquid 139 is delivered from the reservoir 112 to the drying chamber 110 via the drying liquid transfer pump 118. The drying liquid 139 is stored in the drying liquid reservoir 112 when not in use, and can be reused for several batch immersion processes, instead of being discarded after a single use. The drying liquid 139 is transferred through the drying liquid filter 120 to remove contaminants prior to reaching the drying chamber 110. The drying liquid filter 120 can comprise a membrane-type filter, such as are widely used in the semiconductor fabrication industry. The filter 120 helps remove particulate matter from the drying liquid 139. The configuration of the pump 118 and valves 124-130 also allows the use of fluid recirculation, if desired. That is, with the drying chamber 110 filled with drying liquid 139, and with valves 124 and 130 open and valves 126 and 128 closed, the drying liquid pump 118 can circulate the drying liquid 139 into and out of the drying chamber 110 without changing the drying liquid volume, to further agitate the drying liquid and increase the penetration of the drying liquid to pockets of trapped rinse water on the substrates 136.

The time period of immersion of the substrates 136 can vary. It is desirable that the substrates 136 be immersed long enough to achieve substantially complete wetting of the substrates 136, wherein drying liquid 139 penetrates into substantially all channels and features of the substrates 136. A variety of factors, such as the type of substrate and the specific geometry of the surface features of the substrate (e.g., depth and width of etched channels, etc.) can influence the time needed to achieve substantially complete wetting. It has been found that immersion of many substrates 136 in the drying liquid for about one to five minutes is frequently effective. However, it is believed that immersion times of as little as a few seconds up to as much as 10-15 minutes or more can be suitable in some circumstances, though it is generally desirable to reduce the immersion time in the interest of process time.

After the substrates 136 have been immersed in the drying liquid for a suitable time period, with valves 124 and 128 open and valves 126 and 130 closed, the drying liquid 139 can be drained or pumped from the drying chamber 110 back to the reservoir 112. This is step 206 in FIG. 2. In this way, the substrates 136 are removed from the drying liquid 139. After successive cycles, residual rinse water from wet substrates 136 will gradually tend to dilute the drying liquid 139 stored in the reservoir 112. Consequently, the drying liquid reservoir 112 can be provided with a drain 140 and drain valve 142, allowing the drying liquid to be drained to waste periodically, and replaced with fresh drying liquid. Alternatively, various methods for removing water from the drying liquid 139 can also be used. For example, the drying liquid can be drained and distilled to remove the excess rinse water, then returned to the reservoir 112. As another example, a molecular sieve can be used to separate the water from the drying liquid.

While the above discussion describes pumping drying liquid into and out of the drying chamber 110, it is to be appreciated that the substrates 136 can be immersed in and removed from the drying liquid in other ways. For example, rather than draining the drying liquid from the drying chamber 110, the substrates 136 can be immersed in and then removed from a standing pool of drying liquid, whether manually by a worker, or by a mechanical device that moves the substrates 136 up and down. Other alternative methods for immersing and removing the substrates 136 can also be used.

After the substrates 136 are removed from the drying liquid 139, the next general step is to expose the substrates 136 to vacuum pressure. In the embodiment shown in FIGS. 1 and 2, this general step involves several sub-steps. After drying liquid has been drained from the drying chamber 110, the drying chamber 110 is then purged with an inert gas. This is step 208 in FIG. 2. Inert gas from the inert gas supply 122 flows through valve 132 and into the drying chamber 110. During the gas purge stage, valve 134 will also be open and the vacuum pump 116 will be operated to allow the inert gas to displace the atmosphere in the drying chamber 110. Nitrogen gas can be used for purging the drying vessel, but other inert gasses can also be used, such as argon.

It has been found that it is desirable to heat the inert gas to an elevated temperature prior to introducing it to the drying chamber 110. Heated gas enhances the drying process by heating the substrates 136 and replacing any drying liquid vapor inside the tank with a dry gas. The heated inert gas can also increase safety by displacing any oxygen inside the chamber 110, which can be desirable where the drying liquid can leave flammable vapors. To that end, inert gas from the inert gas supply 122 is caused to flow through the inert gas heater 114 on its way to the drying chamber 110. The gas heater 114 can comprise, for example, a conventional type of heater having resistive electric heating coils over which the gas flows. These types of heaters are well known and widely available. The hotter the gas is, the better it will tend to evaporate remaining drying liquid on the substrate. In use, the purge gas is frequently heated to a temperature of about 90.degree. to about 100.degree. C., though a temperature range of about 70.degree. to about 120.degree. C. can also be used. Higher temperatures can also be used, limited primarily by the materials of the drying system and various practical considerations.

After the drying chamber 110 has been drained of the drying liquid 139 and purged with inert gas, the drying chamber is then evacuated to low pressure via the vacuum pump 116. This is step 210 in FIG. 2. When the pressure inside the chamber 110 is lowered to a suitable vacuum pressure, substantially all remaining drying liquid 139 and rinse water left on the substrates 136 quickly evaporates. The vacuum pressure that is applied can vary. It is believed that a low pressure below 100 torr, and particularly in the range of about 100 torr to about 10 torr, and more particularly in the range of about 50 torr to about 10 torr, can be used. Lower pressures can also be used, but require additional time and energy to reach. In one embodiment, the drying chamber 110 has been evacuated to a pressure of 10 torr. At that low final pressure, it has been found that there is essentially no need to maintain the minimum pressure for any length of time. The pumping time involved in reaching a final low pressure can be sufficient to allow complete evaporation of remaining drying liquid 139. However, where a higher final vacuum pressure is used, it can be desirable to hold the final pressure for some length of time, from seconds to minutes, depending on the pressure, in order to allow all residual drying liquid to evaporate. It can also be desirable to maintain the low pressure longer depending on the material of the substrate carrier. It is desirable, however, not to lower the pressure too quickly, so as to avoid freezing the drying liquid 139 on the substrates 136 before the liquid 139 evaporates.

The vacuum pump 116 can comprise an oil-less dry pump. In semiconductor applications, vacuum pressure is frequently provided using an oil-less dry pump to minimize contamination. It is to be understood that the pump 116 shown in FIG. 1 is intended to represent any pumping apparatus or system, whether employing one pump or multiple pumps. Those of skill in the art will recognize that different types and sizes of pumps are suitable for attaining different pressure levels. For example, in one embodiment, a first vacuum pump is used to reach a first low pressure, and then a second larger pump is used to reach a second lower pressure within the drying chamber. Other methods and apparatus for providing the vacuum pressure can also be used. For example, jet ejectors can be used to create vacuum pressure in the range discussed herein. A single-stage steam jet ejector can be used, or a multi-stage compressed air jet ejector can be used, though the latter is believed to be less efficient.

In one embodiment, while applying vacuum pressure to the drying chamber 110, the walls of the drying chamber 110 can be simultaneously heated to a pre-determined elevated temperature. This elevated temperature can be in a range similar to that of the heated inert gas used in the purge stage, such as about 70.degree. to about 120.degree. C. This heating of the drying chamber walls can enhance the evaporation of the liquid on the substrates 136. Heating of the walls of the drying chamber 110 can occur via electric coil heaters 146 attached to the outside of the drying chamber walls. Other heating devices and methods can also be used.

After the substrates 136 have been dried, the drying chamber 110 can then be back-filled with inert gas, such as Nitrogen, from the inert gas supply 122, to bring the drying chamber back to atmospheric pressure. This is step 212 in FIG. 2. As before, the inert gas can be heated via the inert gas heater 114 to the temperature level discussed above before it is introduced into the chamber 110, to further enhance the drying process. It can be desirable to use a high-purity diffuser 144 on the backfill connection to the chamber 110 to help reduce the backfill gas velocity into the chamber 110, and to minimize any possible particle contamination on the surface of the substrates 136.

Following the inert gas backfill, the drying chamber 110 can be opened and the dry substrates 136 can be removed. This is step 214 in FIG. 2. At this point, the substrates 136 will be more completely dry than with other methods, and will be ready for subsequent process steps, with less likelihood of water spots and contamination than are achieved with some other drying methods.

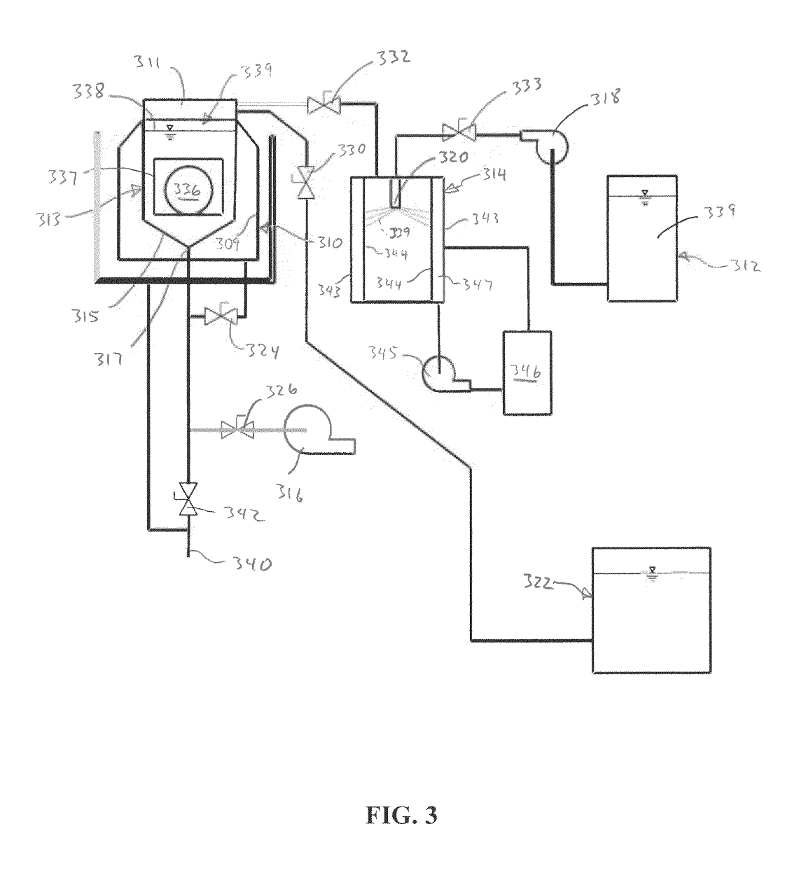

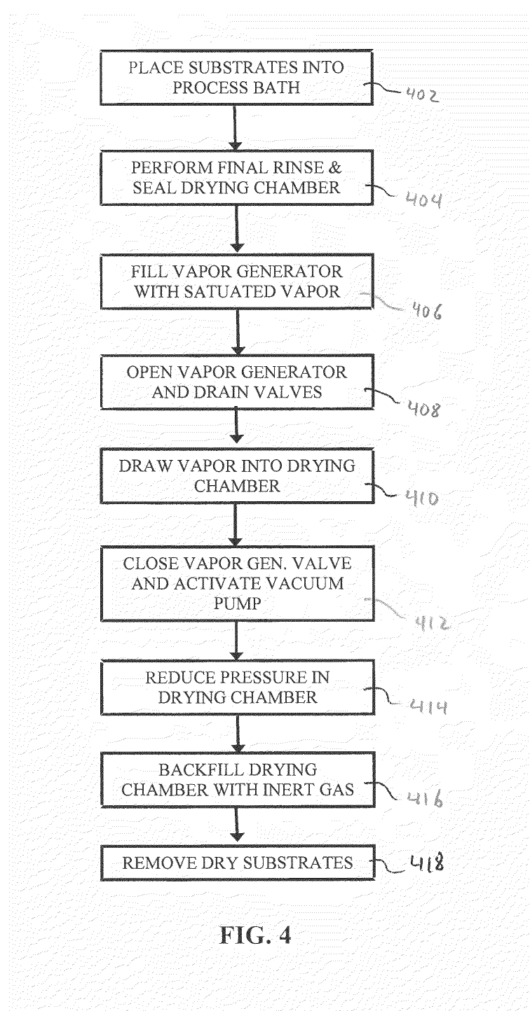

A schematic diagram of another embodiment of a semiconductor drying system is shown in FIG. 3. A flowchart outlining the process steps performed in a method for drying substrates using the apparatus of FIG. 3 is shown in FIG. 4. Like the system and method shown and described above, the system and method outlined in FIGS. 3 and 4 also enables the drying of substrates with high aspect ratios, but does so in a slightly different way. This system and method dries the substrates by coating them with a vaporized drying liquid via condensation, rather than immersion, prior to exposing the substrates to a vacuum atmosphere. Advantageously, a single process chamber can be used for both the liquid condensation and vacuum process steps.

The embodiment shown in FIG. 3 includes a drying chamber 310, which is in fluid communication with a vapor generator 314 and a vacuum pump 316. The drying chamber 310 and other elements of the system are shown with their associated conduits, valves, and other components. The drying chamber 310 can include an openable lid or door 311, which allows access to the interior of the chamber 310, but which can be closed to provide an airtight seal during use. Disposed within the drying chamber 310 is a process bath tub 313, which has a bottom 315 that is steeply sloped toward a drain 317 to promote drainage of fluids without providing locations for particles to collect. The process bath tub 313 is designed such that a rinse of substrates 336 can be performed therein prior to drying. The process bath tub 313 can be made of a variety of materials, including polymers, ceramics, or metals. The process bath tub 313 and the drying chamber 310 are connected with an equalization valve 324 to equalize the pressure when a vacuum is drawn. That is, the equalization valve 324 equalizes the pressure between the exterior and interior of the process bath tub 313, so that these pressures are equal regardless of the pressure within the process chamber 310.

The drying chamber 310 is a pressure vessel, capable of containing vacuum pressure relative to standard atmospheric pressure. The drying chamber 310 can also be configured to be capable of containing higher pressures, above atmospheric pressure, if desired. In one embodiment, the drying chamber 310 is made of stainless steel, which is strong and resistant to a wide variety of chemical agents. Drying chambers made of other materials can also be used.

One feature of this system and method is the use of a vaporized drying fluid for drying semiconductor substrates. The vapor generator 314 is in fluid communication with a drying liquid reservoir 312, which contains a drying fluid 339, and a drying liquid transfer pump 318 is provided to pump the drying liquid 339 from the drying liquid reservoir 312 to the vapor generator 314. Semiconductor-grade IPA is typically used as the drying fluid, because it combines several desirable properties, such as high miscibility in water, low surface tension, high vapor pressure, high molecular weight, and high purity. These properties are highly desirable in a drying fluid to allow it to easily displace residual de-ionized (“DI”) rinse water, and quickly evaporate without leaving behind any contamination or “water spots.” The drying liquid transfer pump 318 can be an oil-less centrifugal pump like the drying liquid pump described above (118 in FIG. 1).

A heating fluid heater 346 and heating fluid pump 345 are in fluid communication with a heat jacket 347 of the vapor generator 314. In the depicted embodiment, the vapor generator is a tube-in-tube heat exchanger, having an outer wall 343 and an inner wall 344. The heat jacket 347 occupies the space between the inner wall 344 and outer wall 343. The inner wall 344 provides an interior surface of the vapor generator 314, and is used to generate the drying fluid vapor. A heating fluid, such as propylene glycol, is circulated by the heating fluid pump 345 through the heater 346 and the heat jacket 347 between the interior wall 344 and exterior wall 343 of the vapor generator 314. The heating fluid is heated by the heater 346 to a temperature at or near the boiling point of the drying fluid 339. When drying fluid 339 is sprayed onto the heated inner wall 344 of the vapor generator 314, it rapidly evaporates.

Although not shown in FIG. 3, the walls 309 of the drying chamber 310 can also include a heating mechanism like that shown above in FIG. 1. This allows the drying chamber 310 to be heated to a pre-determined elevated temperature in the manner discussed above. The drying chamber 310 is also in fluid communication with a deionized water supply 322, which provides a supply of rinse water for a final rinse step. As discussed in more detail below, a variety of fluid conduits and valves are also provided to interconnect all of the elements of FIG. 3 to allow the transfer of fluids.

In the embodiment shown in FIG. 3, a single drying chamber 310 is used for both a final rinse and drying process. Viewing the flowchart of FIG. 4 in conjunction with FIG. 3, at the beginning of the process a batch of wet semiconductor substrates 336, usually batch processed in a process cassette or carrier 337, are placed in the process bath tub 313 inside the drying chamber 310, and the chamber lid 311 is closed. This is step 402 in FIG. 4. The substrates 336 are semiconductor substrates presumably having residual rinse water remaining from a previous processing step.

A final rinse is performed in the process bath tub 313, in which the bath tub 313 is filled with rinsing fluid 339, and the rinsing fluid is circulated within the bath tub 313 for a selected time interval. Specifically, with valves 332, 326 and 342 closed, and valve 330 open, rinse fluid (e.g. deionized water) flows from the deionized water supply 322 into the process bath tub 313 until the tub is filled to some fill level sufficient to immerse the substrates 336. Such a fill level creates a free surface 338 of the rinse water, and leaves or defines a head space 339 in the upper part of the chamber. The free surface 338 of the deionized rinse water can be at a level inside the drying chamber 310 such that it reduces or substantially completely eliminates the head space 339, so that there is little or no atmosphere in the drying chamber 310 at the beginning of the process. This approach reduces the dilution of the drying fluid vapor during introduction to the drying chamber.

After sufficient rinse water has been provided to the process bath tub 313 to fill it to the desired level, valve 330 is closed and the rinse water is circulated within the tub (e.g. in a manner as outlined above) to perform a final rinse of the substrates 336. This is step 404 in FIG. 4. In this step, the drain valve 342 remains closed, and the drying chamber 310 is sealed. The temperature of the deionized rinse water can be in the range of 15 to 30 degrees Celcius, so that it cools the substrates 336. As discussed below, this helps promote a temperature differential between the substrates 336 and the vaporized drying fluid, enhancing condensation of the drying fluid on the substrate. The time period of immersion and rinsing of the substrates 336 in the rinse water can vary. As a general matter, it is desirable that the substrates 336 be immersed long enough to achieve substantially complete wetting of the substrates 336, so that rinse water penetrates into substantially all channels and features of the substrates 336.

Either before and/or during this final rinse step, and in preparation for the subsequent drying steps, the walls of the vapor generator 314 are heated to a suitable elevated temperature by activating the heating fluid heater 346 and circulating the heating fluid using the heating fluid pump 345. When the vapor generator 314 has reached a sufficient temperature, valve 333 is opened and drying fluid pump 318 is activated to pump drying fluid 339 from the drying fluid tank 312 into the vapor generator 314. The vapor generator 314 includes a spray nozzle 320, which sprays the drying fluid 339 against the heated walls of the vapor generator 314, causing the drying fluid to rapidly vaporize. Over a period of time, depending upon the size and temperature of the vapor generator 314, and the characteristics of the drying fluid 339 and of the drying fluid pump 318, the vapor generator 314 will fill with vaporized and heated drying fluid 339 that is at an elevated pressure. This is step 406 in FIG. 4. It is desirable that the drying fluid vapor be a saturated vapor.

Once a suitable quantity of saturated drying fluid vapor at a suitable temperature and pressure is present in the vapor generator 314 and the final rinse step is completed, valve 332 between the drying chamber 310 and the vapor generator 314 is opened, and valve 330 is closed and drain valve 342 is opened to drain substantially all of the rinse water through the drain 340. This is step 408 in FIG. 4. In this draining step a small quantity of rinse water may be left behind in the form of droplets on the surfaces of the process bath tub 313 or the substrate cassette 337, and some will be left on the surface of the substrates 336. However, the tub 313 will be considered substantially drained when the free surface 338 of the rinse water drops below the level of the drain 317 and reaches the drain valve 342. In this condition there will be relatively little rinse water remaining in the drying chamber 310 as a whole, which will allow the system to absorb and evaporate the remainder in the further steps described below.

Because the drying chamber 310 is sealed, as the rinsing fluid 339 drains from the process bath tub 313, the draining of the water acts somewhat like a piston in a cylinder, and naturally draws the drying fluid vapor into the drying chamber 310 from the vapor generator 314. That is, the free surface 338 of the receding rinse water drops downward within the process bath tub 313, and thus creates reduced pressure by expanding the volume of the head space 339 within the drying chamber 310. In one embodiment, removal of the deionized rinse water causes the static pressure inside the drying chamber 310 to be reduced below ambient pressure to a level of 300-600 torr. The vaporized drying fluid naturally flows into this partial vacuum, and fills the head space 339 of the drying chamber 310. The transfer of the drying liquid vapor to the drying chamber 310 can be further promoted by continuing to produce additional drying liquid vapor in the vapor generator 314 at reduced ambient pressure while the process bath tub 313 is draining and vapor is flowing into the drying chamber 310.

As the rinse water recedes and the drying fluid vapor fills the expanding head space 339 of the drying chamber 310, the drying fluid vapor naturally condenses on the substrates 336 as they are gradually exposed by the draining rinse water. This is step 410 in FIG. 4. As noted above, condensation of the vapor upon the substrates 336 can be facilitated by a relatively cooler temperature of the substrates. This aspect of this system and method is significantly different than other approaches. Some other semiconductor drying systems use draining rinse water as a mechanism for employing the meniscus effect, in order to draw rinse water off of a substrate. In this case, however, the draining rinse water is used essentially as a mechanical piston that changes pressure within the drying chamber by expanding the volume of the head space 339 as the free surface 338 of the rinse water recedes, and thereby draws vaporized drying fluid into the drying chamber 310.

In the system shown in FIG. 3, the walls of the drying chamber 310 can be heated to a pre-determined temperature to cause the drying fluid to preferentially condense on the substrates. The walls of the drying chamber 310 can be heated to a temperature in the range mentioned above with respect to the embodiments of FIG. 1. By condensing drying fluid on the substrates, and thus coating them, all surfaces of the substrate material can be adequately wetted with the drying fluid. This allows rinsing fluid that may have been trapped by high aspect ratio substrate features, to be absorbed into the bulk drying liquid, and removed from the chamber when the pressure is subsequently dropped.

The substrates 336 can be left in this condition for a period of time that is long enough to achieve substantially complete wetting of the substrates 336, so that the drying fluid 339 penetrates into substantially all channels and features of the substrates 336. A variety of factors, such as the type of substrate and the specific geometry of the surface features of the substrate (e.g., depth and width of etched channels, etc.) can influence the time needed to achieve substantially complete wetting. It has been found that for many substrates 336 contact with the drying fluid for about one to five minutes is frequently effective. However, it is believed that as little as a few seconds up to as much as 10-15 minutes or more can be suitable in some circumstances, though it is generally desirable to reduce the immersion time in the interest of process time. After the rinse water drains, the drain valve 342 is closed.

One aspect of this system and method is the evacuation of the drying chamber to near vacuum after the introduction of the vaporized drying liquid. After an interval suitable to allow the desired contact of condensed drying fluid vapor on the substrates 336, the valve 332 between the vapor generator 314 and the drying chamber 310 can be closed. Thereafter, the vacuum pump valve 326 is opened and vacuum pump 316 is activated. At the same time, the process bath equalization valve 324 is opened, so that the pressure in the process bath tub 313 and in the drying chamber 310 as a whole are equalized. This is step 412 in FIG. 4.

With the vacuum pump 316 operating, the pressure inside the chamber 310 is lowered to a predetermined pressure, to quickly evaporate the remaining drying fluid and rinsing fluid left on the substrates 336. This is step 414 in FIG. 4. When the pressure inside the chamber 310 is lowered to a suitable vacuum pressure, substantially all remaining drying liquid 339 and rinse water left on the substrates 336 quickly evaporates. The vacuum pressure that is applied can vary, and can be in the range discussed above with respect to the embodiment of FIG. 1. At a suitable low final pressure, the minimum pressure can be maintained for a time interval sufficient to allow complete evaporation of remaining drying liquid 339. As discussed above with respect to the embodiment of FIG. 1, the vacuum pump 316 is intended to represent any pumping apparatus or system, whether employing one pump or multiple pumps, or other types of devices for pumping fluid from the drying chamber 310. As with many semiconductor applications, the vacuum pump can be an oil-less dry pump, which helps to minimize contamination.

While applying vacuum pressure to the drying chamber 310, the walls of the drying chamber 310 can be simultaneously heated to an elevated temperature, as discussed above. This heating of the drying chamber walls can enhance the evaporation of the liquid on the substrates 336. While the apparatus for heating of the walls of the drying chamber 310 is not shown in FIG. 3, this apparatus can be similar to that shown in FIG. 1.

After the substrates 336 have been dried, the drying chamber 310 can then be back-filled with inert gas, such as Nitrogen, to bring the drying chamber 310 back to atmospheric pressure. This is step 416 in FIG. 4. While the specific apparatus for supplying inert gas to the drying chamber 310 is not shown in FIG. 3, this apparatus can be similar to that shown in FIG. 1. As discussed above with respect to the system in FIG. 1, the inert gas can be heated to an elevated temperature before it is introduced into the chamber 310, to further enhance the drying process. The heated inert gas heats the substrates 336 and effectively replaces any drying liquid vapor inside the tank with a dry gas. The heated inert gas can also increase safety by displacing any oxygen inside the chamber 310, which can be desirable where the drying liquid can leave flammable vapors. A diffuser (not shown in FIG. 3) on the backfill connection to the chamber 310 can be provided to help reduce the backfill gas velocity into the chamber 310, and to minimize any possible particle contamination on the surface of the substrates 336.

Following the inert gas backfill, the drying chamber 310 can be opened and the dry substrates 336 can be removed. This is step 418 in FIG. 4. At this point, the substrates 336 will be more completely dry than with other methods, and will be ready for subsequent process steps, with less likelihood of water spots and contamination than are achieved with some other drying methods.

By the methods disclosed herein, semiconductor substrates having MEMS devices, high aspect ratio features, deep vias, etc. on the surface can be dried effectively, thus reducing the likelihood of water spot contamination, stiction, or oxidation damage to semiconductor components. Unlike prior methods, this system and method completely immerses substrates in a drying liquid, allowing more complete displacement of rinse water that may be trapped in deep vias or other high aspect ratio features. At the same time, the method is relatively simple and uses well known materials and technology to accomplish the desired result in a new way. Advantageously, a single process chamber can be used for both the liquid immersion and vacuum drying steps. It is also to be appreciated that, while the system and method disclosed herein are effective for drying substrates having high aspect ratio features, it is not limited to that use. This method can be used with any substrates, whether they have high aspect ratio features or not.

Although the present disclosure has been described in terms of certain specific embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure, and the present disclosure is to be understood to include all such modifications and variations are would be apparent to one skilled in the art.

What is claimed is:

1. A method for drying a wet substrate, comprising:
immersing the wet substrate in a rinsing liquid in a sealed drying chamber;
producing a volume of vaporized drying fluid in a vapor generator;
establishing fluid communication between the vapor generator and the drying chamber;
transferring the vaporized drying fluid to the drying chamber by removing the rinsing liquid from the drying chamber;
allowing the vaporized drying fluid to condense on the wet substrate;
providing vacuum pressure within the drying chamber; and
backfilling the drying chamber with an inert gas to substantially achieve atmospheric pressure.

2. A method in accordance with claim 1, further comprising the step of agitating the rinsing liquid while the substrate is immersed therein.

3. A method in accordance with claim 1, wherein the substrate is immersed in the rinsing liquid in a process bath tub that is disposed within the drying chamber.

4. A method in accordance with claim 3, wherein the process bath tub and the drying chamber are pressure-equalized.

5. A method in accordance with claim 1, wherein the rinsing liquid is deionized water.

6. A method in accordance with claim 1, wherein the rinsing liquid has a temperature of about 15° C. to 30° C.

7. A method in accordance with claim 1, wherein transferring the vaporized drying fluid to the drying chamber comprises draining the rinsing liquid from the drying chamber so as to produce a pressure drop in a head space of the sealed drying chamber, the vapor generator being in fluid communication with the head space.

8. A method in accordance with claim 1, wherein the rinsing liquid initially defines a fill level inside the drying chamber that substantially displaces all head space in the drying chamber.

9. A method in accordance with claim 1, wherein a static pressure inside the drying chamber is reduced by the removal of the rinsing liquid, to a level below ambient pressure of about 300 to about 600 torr.

10. A method in accordance with claim 1, wherein producing the volume of vaporized drying fluid in the vapor generator comprises spraying liquid drying fluid against heated interior sidewalls of the vapor generator.

11. A method in accordance with claim 10, wherein the interior sidewalls of the vapor generator are heated to a temperature that is approximately at a boiling point of the drying fluid.

12. A method in accordance with claim 1, further comprising producing additional drying liquid vapor in the vapor generator at reduced ambient pressure while removing the rinsing liquid from the drying chamber, to promote the transfer of the drying liquid vapor to the drying chamber.

13. A method in accordance with claim 1, wherein the drying liquid comprises isopropyl alcohol.

14. A method in accordance with claim 1, further comprising heating the drying chamber during at least a portion of the process of drying the wet substrate.

15. A method in accordance with claim 1, wherein exposing the substrate to vacuum pressure comprises exposing the substrate to a pressure below about 100 torr.

16. A method in accordance with claim 1, further comprising heating the inert gas to a temperature of about 70° C. to 120° C. prior to backfilling the drying chamber.

17. A method in accordance with claim 1, wherein the inert gas comprises nitrogen.

18. A method for drying a wet semiconductor substrate, comprising:
immersing the wet substrate in a rinsing liquid in a process bath in a drying chamber;
vaporizing a volume of drying fluid in a vapor generator;
transferring the vaporized drying fluid to the drying chamber, and allowing the vaporized drying fluid to condense on the wet substrate, by draining the rinsing liquid from the process bath, the receding rinsing fluid creating a partial vacuum pressure of about 300 to about 600 torr in the drying chamber;
providing vacuum pressure below about 100 torr within the drying chamber; and
backfilling the drying chamber with an inert gas to substantially achieve atmospheric pressure.

19. A method in accordance with claim 18, wherein the rinsing liquid has a temperature of about 15° C. to 30° C.

20. A method in accordance with claim 18, wherein the rinsing liquid initially defines a fill level in the process bath that substantially displaces all head space in the drying chamber.

21. A method in accordance with claim 18, wherein producing the volume of vaporized drying fluid in the vapor generator comprises spraying liquid drying fluid against interior sidewalls of the vapor generator that are heated to a temperature that is approximately at a boiling point of the drying fluid.

22. A method in accordance with claim 18, further comprising producing additional drying liquid vapor in the vapor generator at reduced ambient pressure while removing the rinsing liquid from the drying chamber, to promote the transfer of the drying liquid vapor to the drying chamber.

23. A method in accordance with claim 18, further comprising heating the drying chamber during at least a portion of the process of drying the wet substrate.

24. A system for drying wet substrates, comprising:
an openable drying chamber, defining a pressure vessel having an interior, having an airtight seal when closed, configured to contain a rinsing liquid selectively filled to a depth sufficient to substantially completely immerse a substrate therein;
a drain, in selective fluid communication with the interior, configured to allow the rinsing liquid to be drained from the drying chamber; and
a vapor generator, in selective fluid communication with the drying chamber, configured to generate vaporized drying fluid, wherein draining of the rinsing liquid creates a partial vacuum within the pressure vessel, thereby drawing the vaporized drying fluid into the drying chamber.

25. A system in accordance with claim 24, further comprising a vacuum pump, in fluid communication with the interior, configured to produce vacuum pressure within the drying chamber.

26. A system in accordance with claim 25, wherein the vacuum pump is configured to produce a vacuum pressure in the drying chamber below about 100 torr.

27. A system in accordance with claim 25, further comprising an inert gas supply, in fluid communication with the pressure vessel, configured to backfill the drying chamber with inert gas to substantially atmospheric pressure after vacuum pressure has been applied thereto.

28. A system in accordance with claim 24, wherein the drying chamber includes a process bath having a sloped bottom surface in communication with the drain, configured to promote drainage of liquids and suspended solids therefrom.

29. A system in accordance with claim 24, wherein the vapor generator comprises a closed chamber having heated interior sidewalls, and a nozzle, configured to spray liquid drying fluid against of the heated interior sidewalls.

30. A system in accordance with claim 29, wherein the heated interior sidewalls are heated to a temperature that is that is approximately at a boiling temperature of the drying liquid.

31. A system in accordance with claim 24, wherein the rinsing liquid is deionized water and the drying liquid is isopropyl alcohol.

32. A system in accordance with claim 24, further comprising a heating device, associated with the pressure vessel, configured to heat the drying chamber to an elevated temperature.
